(19) United States
(12) Patent Application Publication
(10) Pub. No.: US 2026/0278577 A1
(43) Pub. Date: Sep. 17, 2026

(54) SYSTEMS AND METHODS FOR AUTOMATED EXIT VERIFICATION

(71) Applicant: BJ's Wholesale Club, Inc., Marlborough, MA (US)

(72) Inventor: J Don DAYLEY, Hopkinton, MA (US)

(73) Assignee: BJ's Wholesale Club, Inc., Marlborough, MA (US)

(21) Appl. No.: 19/079,108

(22) Filed: Mar. 13, 2025

(51) Int. Cl. G06Q 20/20; G06N 5/046

(52) U.S. Cl. CPC G06Q 20/203; G06N 5/046

(57) ABSTRACT

Systems and methods provided herein may facilitate store exit verification. Methods may include capturing, in real-time and as a customer approaches an exit, a set of images of one or more items. Methods may include constructing, via a computer vision engine, a preliminary item catalog based on the one or more items detected near the exit. Methods may include constructing, via a machine learning engine and based on the preliminary item catalog, a refined item catalog by cross-referencing attributes of the one or more items against at least one of synthetic data, historical purchase patterns, contextual product groupings, and known inventory information. Methods may include detecting, via a verification engine and in real-time, discrepancies between the refined item catalog and a corresponding transaction log obtained from a transaction database, wherein the customer is allowed to pass through the exit based on the discrepancies.

### BACKGROUND

Current retail verification processes typically prompt store members to present a receipt at the exit to confirm purchased items, ensuring that all items are properly accounted for before leaving the store. This manual method can be time-consuming, cause customer inconvenience, and depend heavily on staff intervention. Although point-of-sale (POS) systems generate detailed transaction logs (TLOGs) that link purchased items to a member’s account, verification of the TLOGs may remain subject to process fallibility. Current automated solutions that rely on classifiers often struggle with variable lighting conditions, evolving product packaging, and the introduction of new items, leading to accuracy and scalability issues.

Despite advancements in retail verification techniques, current methods may still be ineffective in achieving optimal results. Accordingly, there is an impetus to improve verification techniques to overcome existing technological challenges by implementing enhancements such as: increasing the reliability of item verification, reducing inefficiencies associated with the verification process, minimizing customer inconvenience, decreasing the reliance on manual staff intervention, improving the accuracy of automated solutions, and the like.

Consequently, further improvements to retail verification processes may address the aforementioned technical challenges and other challenges not mentioned.

### BRIEF SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an aspect consistent with the present disclosure, a system for store exit verification may include a computer vision engine, the computer vision engine configured to, in real-time and as a customer approaches an exit, construct a preliminary item catalog based on one or more items detected near the exit. The system may further include a machine learning engine communicatively coupled to the computer vision engine and having one or more machine learning models, the one or more machine learning models trained to construct, based on the preliminary item catalog, a refined item catalog by cross-referencing attributes of the one or more items against at least one of synthetic data, historical purchase patterns, contextual product groupings, and known inventory information. The system may further include a verification engine communicatively coupled to the machine learning engine and a transaction database, the verification engine configured to detect, in real-time, discrepancies between the refined item catalog and a corresponding transaction log obtained from the transaction database, wherein the customer is allowed to pass through the exit based on the discrepancies.

In another aspect consistent with the present disclosure, a method for store exit verification may include capturing, in real-time and as a customer approaches an exit, a set of images of one or more items. The method may further include constructing, via a computer vision engine, a preliminary item catalog based on the one or more items detected near the exit. The method may further include constructing, via a machine learning engine and based on the preliminary item catalog, a refined item catalog by cross-referencing attributes of the one or more items against at least one of synthetic data, historical purchase patterns, contextual product groupings, and known inventory information. The method may further include detecting, via a verification engine and in real-time, discrepancies between the refined item catalog and a corresponding transaction log obtained from a transaction database, wherein the customer is allowed to pass through the exit based on the discrepancies.

In another aspect consistent with the present disclosure, a system for store exit verification, may include one or more point of sale units configured to construct a transaction log based on a transaction by a customer and output the transaction log to a transaction database. The system may further include one or more sensing devices configured to, in real-time and as a customer approaches an exit, capture images of one or more items near the exit. The system further may further include a primary unit having one or more processors coupled to a memory having computer-readable instructions stored thereon. The primary unit may include a computer vision engine communicatively coupled to the one or more sensing devices, the computer vision engine configured to construct a preliminary item catalog based the on one or more items. The primary unit may further include a machine learning engine communicatively coupled to the computer vision engine and having one or more machine learning models, the one or more machine learning models trained to construct, based on the preliminary item catalog, a refined item catalog by cross-referencing attributes of the one or more items against at least one of synthetic data, historical purchase patterns, contextual product groupings, and known inventory information. The primary unit may further include a verification engine communicatively coupled to the machine learning engine and a transaction database, the verification engine configured to detect, in real-time, discrepancies between the refined item catalog and the transaction log obtained from the transaction database, wherein the customer is allowed to pass through the exit based on the discrepancies. The system may further include a device communicatively coupled to the verification engine and having a user-interface configured to enable a user to view informatics based on the discrepancies.

Other aspects of the present disclosure provide: one or more devices (e.g., apparatuses) operable, configured, or otherwise adapted to perform the aforementioned methods as well as those described elsewhere herein; a non-transitory, computer-readable media including computer-executable instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus including means for performing the aforementioned methods as well as those described elsewhere herein. By way of example, an apparatus may include a processing system, or processing systems cooperating over one or more message passing interfaces.

Any combinations of the various aspects and implementations disclosed herein can be used in a further aspect, consistent with the disclosure. These and other aspects and features can be appreciated from the following description of certain aspects presented herein in accordance with the disclosure and the accompanying drawings and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an architecture diagram illustrating an example of an enhanced exit verification architecture, according to one or more aspects of the present disclosure.

FIG. 2 is a flow diagram illustrating an example of an enhanced exit verification procedure, according to one or more aspects of the present disclosure.

FIG. 3 is a flow diagram illustrating an example of an enhanced point-of-sale (POS) transaction procedure, according to one or more aspects of the present disclosure.

FIG. 4 is a flow diagram illustrating an example of an enhanced computer vision array image capture procedure, according to one or more aspects of the present disclosure.

FIG. 5 is a flow diagram illustrating an example of an enhanced continuous learning procedure, according to one or more aspects of the present disclosure.

FIG. 6 is a flow diagram illustrating an example method for enhanced exit verification, according to one or more aspects of the present disclosure.

FIG. 7 is a diagram of a system having device(s) for enhanced exit verification, implemented according to at least one aspect of the present disclosure.

FIG. 8 is a block diagram of a computer system that may be used to implement one or more of the systems or methods described herein in accordance with certain embodiments.

FIG. 9 depicts a cloud computing environment that can be used to perform one or more actions according to an aspect of the present disclosure.

### DETAILED DESCRIPTION

Aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the aspects disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Aspects in accordance with the present disclosure generally relate to item verification techniques, and more particularly to systems and methods for automated exit verification of purchased items using integrated computer vision and machine learning (e.g., generative artificial intelligence (GenAI)).

Disclosed herein are systems and methods to automate and improve verification of purchased items as a customer (e.g., a member) exits a store, utilizing a combination of computer vision techniques, GenAI models, and real-time cross-referencing against POS transaction logs. For example, utilizing systems and methods described herein, member’s transaction details (TLOG) from one or multiple POS systems may first be recorded and associated with their account. As the member approaches a facility exit, an array of high-resolution cameras may capture images of the cart from various angles. A computer vision model may then identify items, producing preliminary item lists (e.g., catalogs) along with confidence scores. A GenAI model may then cross-references these initial results against historical data, synthetic training sets, contextual product associations, and the transaction log, refining the final item catalog with improved accuracy and plausibility checks. Once the system confirms that the detected items match the purchased catalog, the system may grant exit clearance to the member, in many cases without manual inspection. This integrated system may reduce false positives, quickly adapt to new product lines, and provide instantaneous or near-instantaneous cart verification.

### Aspects Related to Enhanced Exit Verification Architecture

Aspects described herein provide an enhanced exit verification architecture (e.g., enhanced exit verification architecture 100).

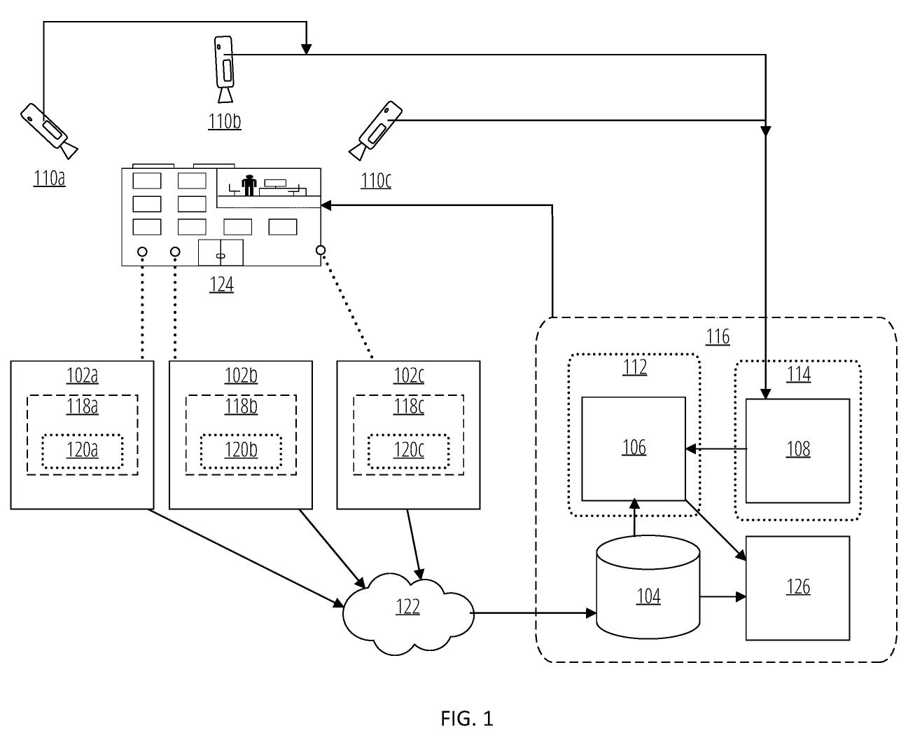

The illustrative diagram of FIG. 1 provides an example of enhanced exit verification architecture 100. Enhanced exit verification architecture 100 includes one or more point of sale units 102a-c, a transaction database 104, a machine learning engine 106, a computer vision engine 108, a verification engine 126, and an array of sensing devices 110a-c (e.g., an array of optical devices, such as an array of cameras). In at least one aspect, enhanced exit verification architecture 100 includes a machine learning unit 112 and a computer vision unit 114. In at least one aspect, enhanced exit verification architecture 100 includes a primary unit 116. In at least one aspect, primary unit 116 includes machine learning unit 112, computer vision unit 114, transaction database 104, and verification engine 126. In at least one aspect, each of the one or more point of service units 102a-c include one of user devices 118a-c (e.g., POS terminals). User devices 118a-c may include one of checkouts tools 120a-c. Communications across the enhanced exit verification architecture 100 may be facilitated by network 122. The enhanced exit verification architecture 100 may be implemented to monitor a facility 124 (e.g., such as a customer storefront, a supply warehouse, or any other facility with POS one or more point of sale units 102a-c).

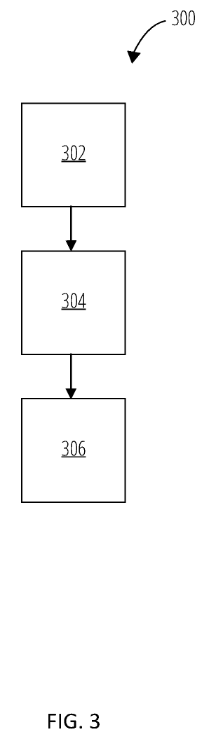

In at least one aspect, an example method of exit verification begins at the enhanced exit verification architecture 100 when a user (e.g., a customer, a member, not pictured) completes a purchase at user device 118a using checkout tool 120a. A TLOG is generated at point of sale unit 102a and forwarded via network 122 to transaction database 104. When the user approaches the facility 124 exit, array of sensing devices 110a-c capture information (e.g., image information, multi-angle image information) regarding a user's purchase. The captured information is delivered to computer vision unit 114, where is processed by computer vision engine 108. Computer vision engine 108 constructs a preliminary catalog (e.g., list, not shown) of identified items associated with the user's purchase and relays the preliminary catalog to machine learning engine 106. Machine learning engine 106 processes the preliminary catalog according to one or more machine learning techniques (e.g., machine learning techniques discussed in detail below). Machine learning engine 106 constructs a refined cart item catalog based on the processing and outputs the refined cart item catalog to verification engine 126. Verification engine 126 then retrieves the generated TLOG from transaction database 104 and correlates the refined cart item catalog against the generated TLOG and detects discrepancies. If verification engine 126 detects discrepancies, primary unit 116 constructs an alert and outputs the alerts to one or more operators associated with the enhanced exit verification architecture 100. If verification engine 126 does not detect discrepancies, primary unit 116 may allow (e.g., via signal) a customer to exit. In at least one example, enhanced exit verification architecture 100 includes a feedback loop (not shown) that updates computer vision engine 108 and/or machine learning engine 106 based on verification results, thereby continuously improving item recognition accuracy and system robustness. The feedback loop is further described below with respect to the procedures 300-500 of FIGS. 3-5.

In at least one aspect, the one or more points of sale units 102a-c may be one or more checkout kiosks located throughout a store (e.g., facility 124 as illustrated in the example of FIG. 1). In at least one aspect, one or more point of sale units 102a-c of enhanced exit verification architecture 100 include user devices 118a-c, which may utilize checkouts tools 120a-c. In at least one aspect, checkouts tools 120a-c may be accessed by user devices 118a-c via network 122. In at least one aspect, user devices 118a-c can be any electronic computing device. User devices 118a-c may be a computing device that has a display. A user can enter control inputs through a user interface (such as a keyboard, item scanner, microphone, or touchscreen). For example, each of user devices 118a-c can include, but are not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 122. In at least one aspect, each of user devices 118a-c may be remote computing devices that includes a tool (e.g., one of checkouts tools 120a-c) having a user-interface configured to allow a user to view POS transaction informatics based on item options at a display device and to make inputs to control visualization of the POS transaction informatics displayed to the user.

Each of user devices 118a-c may include one of checkouts tools 120a-c. Checkouts tools 120a-c may be applications, such as applications running under control of an operating system on one or more point of sale units 102a-c or a web application operating which may be accessed via network 122 and via user devices 118a-c. Checkouts tools 120a-c may be configured or otherwise arranged to access data from user devices 118a-c to, for example, display POS transaction informatics.

In at least one aspect, one or more point of sale units 102a-c may utilize a real-time application programming interface (API) to facilitate retail verification processes. The real-time API may be communicatively coupled to one or more point of sale units 102a-c in a manner which may facilitate the instantaneous or near-instantaneous exchange of data. The real-time API allows for seamless verification of purchased items by linking TLOGs to a member’s account in real-time, ensuring that all items are properly accounted for before the customer leaves facility 124. By leveraging, for example, WebSockets, HTTP/2, or other streaming protocols, the real-time API may facilitate continuous data flow, overcoming challenges associated with manual receipt checks and early automated solutions. This capability enhances the reliability and efficiency of the verification process, reduces customer inconvenience, and minimizes the reliance on manual staff intervention, ultimately improving the overall shopping experience.

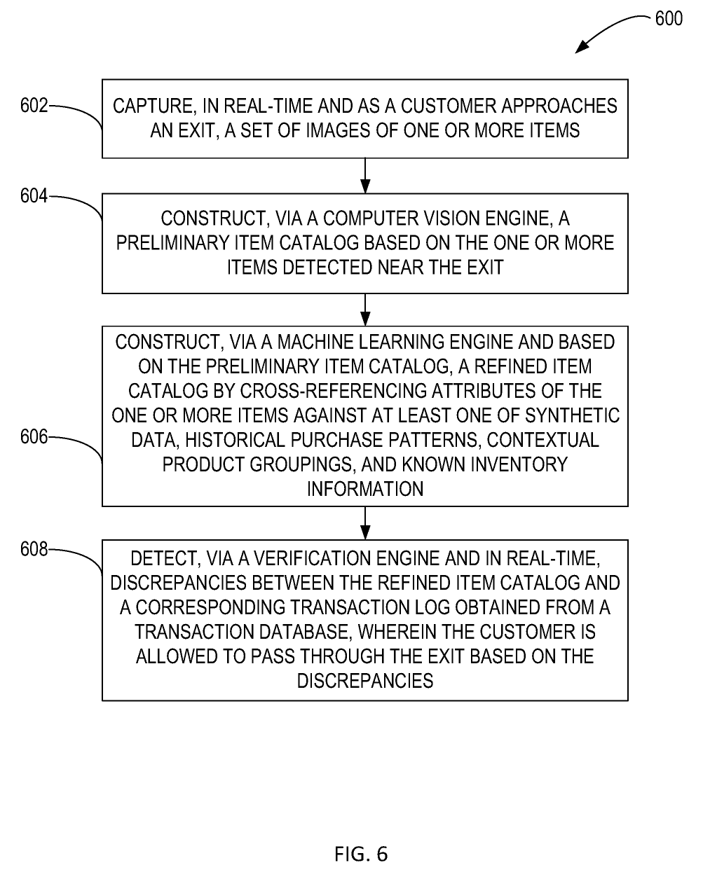

In at least one aspect, transaction database 104 may be practically implemented as one or more databases. In at least one aspect, the database may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. Transaction database 104 may be treated as a data warehouse, data lake, data well, or another storage system. Transaction database 104 may be optimized for querying and analysis, allowing the enhanced exit verification architecture 100 methods described herein (e.g., method 600 of FIG. 6).

In at least one aspect, machine learning engine 106 includes a training engine. In one aspect, machine learning engine 106 includes an inference engine. In one aspect, machine learning engine 106 includes a model selection manager. In at least one aspect, machine learning engine 106 includes one or more machine learning models selected (e.g., by the model selection manager) from a candidate set of large language models (LLMs). Selection of one or more machine learning models may be performed dynamically to ensure high-accuracy and low latency performance of methods provided herein. For example, a model selection manager may evaluate the candidate set of LLMs against historical data, the current TLOGs at 104, and/or the current data captured at array of sensing devices 110a-c, and may select one or more LLMs for refining computer vision information during an exit verification procedure. The one or more LLMs may include any of the LLMs described below. In at least one aspect, the one or more LLMs may be trained (e.g., at the training engine) on at least one of historical data, common product co-occurrences, promotional items, member-specific purchase histories, other specific customer data (e.g., risk profiles), and continuous information (e.g., inventory information updated in real-time), and the like. In at least one aspect, one or more LLMs may be implemented by selecting the appropriate features, splitting the data into training and validation sets, and tuning the model parameters to optimize performance. In at least one aspect, the one or more LLMs may implemented at machine learning engine 106 may be one or more of any other machine learning model suitable to perform methods described herein (e.g., method 600 of FIG. 6), including models that are mentioned and not mentioned in this description.

In at least one aspect, the training engine of machine learning engine 106 may be implemented to refine a preliminary item catalog obtained from computer vision engine 108. In at least one aspect, the training engine trains the machine learning model by inputting at least one training dataset, the training dataset based on at least one of real-time customer information and real-time inventory information, comparing, to the at least one training dataset, at least one outputs of the training engine, and based on the comparing, adjusting one or more weights of the machine learning model. The training engine may refine the preliminary item catalog by applying, for example, the one or more LLMs trained by the training engine and/or selected by the model selection manager. By applying the one or more LLMs, which may be continuously trained, to a preliminary item catalog generated in real-time, the inference engine may facilitate rapid and accurate verification of cart items.

Various aspects described herein can constitute one or more technical improvements over conventional POS validation operations by incorporating enhanced validation at a machine learning engine to recursively adjust the data to better reflect real-time information. For example, the training engine may adjust the weights of the machine learning engine by using real-time customer information and/or real-time inventory information, and then may use the weighted output to retrain the machine learning model facilitates low-latency, high accuracy output from enhanced exit verification architecture 100. Additionally, one or more aspects described herein can have a practical application by training machine learning models to perform the machine learning operations in a flexible manner in accordance with defined real-time exit validation objectives. For example, one or more aspects described herein can incorporate specific, dynamic user information into a machine learning model, making for a highly flexible machine learning model within the architecture of FIG. 1. For instance, the machine learning engine can retrain in response to a discrepancy alert, the discrepancy alert indicating new information which may all the machine learning model generate more precise output. The machine learning engine, by way of the inference engine, may then apply the more precise model.

In at least one aspect, computer vision engine 108 may be a classifier engine. In one example, computer vision engine 108 as implemented in enhanced exit verification architecture 100 may include a data preprocessor, which may clean and transforming image data from array of sensing devices 110a-c into any suitable format for analysis. Cleaning and transforming the image data may involve normalizing the image data, handling missing values within the image data, and feature extraction related to the image data. Computer vision engine 108 may also include an explicit feature extractor that may identify and select relevant attributes from the image data, identifying the relevant attributes to be delivered to a model trainer at the computer vision engine 108.

The model trainer may be configured or otherwise arranged to train a machine learning model for classification. The model trainer may implement machine learning techniques such as decision trees, support vector machines, or neural networks, to learn from the training data. The model trainer identifies patterns and relationships within the image data, adjusting its internal parameters to minimize classification errors. In one example, the model trainer obtains input image data from one or more input sources (e.g., one or more point of sale units 102a-c, transaction database 104, array of sensing devices 110a-c), parses the input image data into training data and control data, sends the training data to an inference manager to apply a current machine learning model to the training data, obtains the output of the current machine learning model as constructed by the inference manager based on the training data, compares the output of the current machine learning model to the control data, and, based on the comparing, adjusts the weights of the machine learning model to correct for discrepancies between the training data and the output of the current machine learning model. This process may be performed iteratively to refine the classifier as more error data and/or input data arrives at the model trainer. Iterative processing may be facilitated by a feedback loop (not shown) which is included in the data flow paths illustrated with respect to FIG. 1.

Computer vision engine 108 may also include a model validator to assesses the performance of the trained model using a separate test dataset, employing metrics such as precision, recall, and F1 score to evaluate accuracy. Computer vision engine 108 may also include the inference manager that applies the trained model to new, unseen data to predict its category. When deployed, the classifier may allow for real-time or near-real-time image data classification, which may then be delivered to machine learning engine 106 for precise refinement. Computer vision engine 108 continuously improves over time as it is exposed to more image data.

Computer vision engine 108 may be implemented as any of several classifier engines, including but not limited to: a decision tree classifier, PyTorch, a support vector machine (SVM), a naïve Bayes classifier, a K-Nearest Neighbors (KNN), a neural network, and a random forest classifier. Each type of classifier engine may be dynamically selected at enhanced exit verification architecture 100 based on the specific requirements of the task, the nature of the image data, and the targeted (e.g., automatically targeted, manually targeted) balance between accuracy and computational efficiency.

In at least one aspect, verification engine 126 may incorporate contextual information, such as purchase patterns, to improve the accuracy of enhanced exit verification architecture 100. Verification engine 126 may operate by systematically checking and validating information from machine learning engine 106 against associated TLOGs at transaction database 104.

In at least one aspect, the array of sensing devices 110a-c may be an array of cameras deployed to capture image (e.g., picture information, video information) about facility 124. In one example, high-resolution digital cameras may be implemented to capture detailed images, which are necessary for identifying various items within a member cart, and/or for verifying barcodes or other identifying features associated with an item. A high-resolution digital camera may have high megapixel counts and advanced image processing technologies that produce sharp, clear images with fine details. This level of detail may capture verifiable information such as product labels, barcodes, and packaging details. In another example, panoramic cameras may be implemented to capture a wide field of view, which may be valuable in a larger retail environment where multiple items or POS units are to be monitored simultaneously.

Enhanced exit verification architecture 100 optionally includes any of machine learning unit 112, computer vision unit 114, and/or primary unit 116, alone or in combination. In at least one aspect, each of machine learning unit 112, computer vision unit 114, and/or primary unit 116 may be practically implemented as one or more units and/or one or more devices. In at least one aspect, each of machine learning unit 112, computer vision unit 114, and/or primary unit 116 may have at least one memory and one or more processors having computer readable instructions stored thereon, which are capable of implementing enhanced data processing schemes as part of the enhanced data processing architecture. In at least one aspect, machine learning unit 112, computer vision unit 114, and/or primary unit 116 may have at least one memory and one or more processors having computer readable instructions stored thereon, which are capable of implementing enhanced data processing schemes as part of the function of the enhanced data processing architecture. The one or more processor(s) of machine learning unit 112, computer vision unit 114, and/or primary unit 116 may be central processing units (CPUs). The one or more processor(s) of machine learning unit 112, computer vision unit 114, and/or primary unit 116 may be graphics processing units (GPUs). Where there is more than one processor, each processor may operate independently from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data.

In at least one aspect, enhanced exit verification architecture 100 may optionally include machine learning unit 112. In one example, machine learning unit 112 may be configured or otherwise arranged to house machine learning engine 106 and may be distinct from and communicatively coupled to computer vision unit 114. In another example, machine learning unit 112 may be part of computer vision unit 114, such that machine learning unit 112 and computer vision unit 114 are the same unit housing both machine learning engine 106 and computer vision engine 108. In one example, machine learning unit 112 may be housed at primary unit 116. In another example, machine learning unit 112 may be distributed or containerized, as opposed to centralized at a supervisory unit. In at least one aspect, machine learning unit 112 is housed at a virtual machine architecture, a server-based architecture, a containerized architecture, and/or a serverless architecture.

In at least one aspect, enhanced exit verification architecture 100 may optionally include computer vision unit 114. In one example, computer vision unit 114 may be configured or otherwise arranged to house computer vision engine 108 and may be distinct from and communicatively coupled to machine learning unit 112. In another example, computer vision unit 114 may be part of machine learning unit 112, such that computer vision unit 114 and machine learning unit 112 are the same unit housing both machine learning engine 106 and computer vision engine 108. In one example, computer vision unit 114 may be housed at primary unit 116. In another example, computer vision unit 114 may be distributed or containerized, as opposed to centralized at a supervisory unit. In at least one aspect, computer vision unit 114 is housed at a virtual machine architecture, a server-based architecture, a containerized architecture, and/or a serverless architecture.

In at least one aspect, enhanced exit verification architecture 100 may optionally include a device (not shown) communicatively coupled to verification engine 126 and having a user-interface configured to enable a user to view informatics based on the discrepancies. In at least one aspect, the device can be any electronic computing device. The device may be a computing device that has a display. A user can enter control inputs through a user interface (such as a keyboard, microphone, or touchscreen). For example, the device can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 122.

In at least one aspect, enhanced exit verification architecture 100 may optionally include primary unit 116, where primary unit 116 acts as a supervisory unit. Supervisory units may include but are not limited to supervisory control and data acquisition (SCADA) systems, building management systems (BMS), and network operations centers (NOC).

In at least one aspect, network 122 may be practically implemented as one or more networks. Network 122 may be a wired network, a wireless network, or a combination of both. In at least one aspect, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IoT) applicability), and the like.

In at least one aspect, facility 124 may be a large facility with an open floor plan designed to accommodate bulk quantities of merchandise. The layout of facility 124 may include wide aisles to facilitate the movement of large shopping carts and pallets. Facility 124 may be divided into various sections, such as groceries, electronics, furniture, clothing, and household goods. Facility 124 may include high ceilings with products stacked on industrial shelving units that reach up to the ceiling, maximizing storage space. A checkout area of facility 124 may include one or more point of sale units 102a-c and may be designed to handle high volumes of customers efficiently, with multiple lanes and self-checkout options. An exit of facility 124 may include a designated area where enhanced exit verification architecture 100 is implemented to verify TLOGs against items detected by machine learning engine 106 to ensure accuracy and prevent theft. The exit may be located near the checkout lanes and equipped with wide doors to accommodate large carts and bulk purchases. In at least one aspect, the exit may include gates. The gates may be configured or otherwise arranged to open to allow customer exit after a purchase has been verified by enhanced exit verification architecture 100.

### Aspects Related to Procedures for Exit Verification

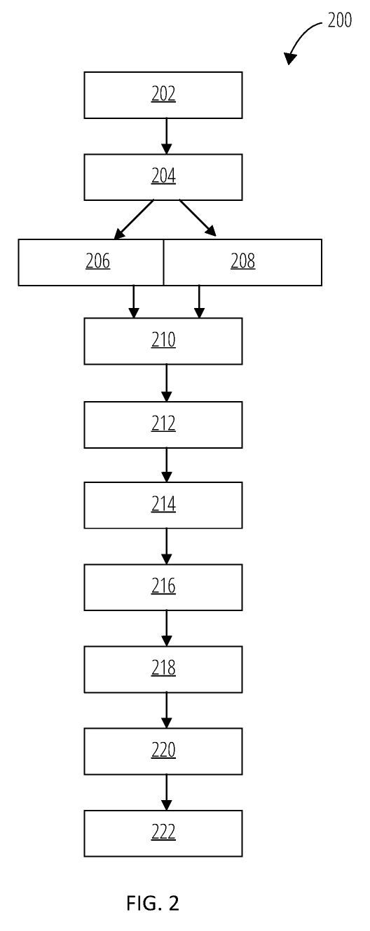

An example of a procedure applied at an enhanced exit verification architecture (e.g., enhanced exit verification architecture 100) is illustrated in the flow diagram of FIG. 2. Specifically, FIG. 2 illustrates a procedure 200 for data flow through an enhanced exit verification architecture and/or enhanced exit verification system.

At operation 202, one or more transactions are made at least one POS system (e.g., one or more point of sale units 102a-c). A POS system may be a traditional payment system with a cashier or may be an express pay system typically associated with “self-check-out” services. At operation 204, in response to the one or more transactions, each POS system generates a TLOG. The TLOG(s) identify all the items in the one or more transactions, including applied discounts and quantities. In some cases, there may be multiple POS systems generating these TLOGs simultaneously. The TLOGs are stored at a transaction database (e.g., transaction database 104) as store inventory and purchase history information. At operation 206, a lookup is performed. At operation 208, a member authentication is performed in association with a given TLOG, such that a member's loyalty and/or account number is identified within the given TLOG based on the member's originating transaction from operation 202.

At operation 210, an array of cameras (e.g., array of sensing devices 110a-c) surround the cart, taking multiple pictures as the customer walks through an exit area. The picture data is then passed to an inferencing engine of a machine learning component (e.g., an engine or a unit, such as machine learning engine 106 and/or machine learning unit 112). At operation 212, each TLOG is collected into a real-time API that correlates each TLOG what a computer vision system (e.g., an engine or a unit, such as computer vision engine 108 and/or computer vision unit 114) inspected member carts. At operation 214, the computer vision system detects one or more objects within the cart and applies a classification module to identify each object. At operation 216, a GenAI module of the machine learning component uses synthetic data generation and contextual reasoning to refine a catalog of objects identified during operation 214. At operation 218, the TLOG and the refined catalog of objects are sent to a verification engine (e.g., verification engine 126).

At operation 220, the verification engine compares the refined catalog of objects with the objects listed the TLOG associated with the originating transaction. Any discrepancies are identified, and the verification results are generated. At operation 222, the verification results are signaled to an exit gate controller, which either opens a gate or requests manual cart review based on the verification results.

In at least one aspect, a risk profile is associated with each loyalty/account number based on an associated member's transaction history. In one example, members with a good history will have a higher credibility score and minor discrepancies may be overlooked based on their risk profile, causing the exit gate controller to open even if the refined catalog does not precisely match the TLOG of the originating transaction. In another example, increased scrutiny may be applied to an entire facility where theft is commonly associated with the entire facility. In this example, minor discrepancies may routinely trigger manual inspections. In certain cases, risk profiles may be adapted to detect and deter reward fraud, where individuals may use a membership number that is not theirs, transacting with rewards or gift cards to obtain cash. In certain cases, membership numbers may be encrypted to prevent reproduction and reward fraud.

In at least one aspect, the format of data collected at POS systems described with respect to FIG. 2 may include quantity, SKU, amount paid, discounts, taxes, category, membership number, whether it was a self-checkout or managed checkout, and the register used.

Procedure 200 confers several improvements over current technology, including improved accuracy and efficiency in verifying transactions at the point of exit. By integrating multiple POS systems with a transaction database and leveraging machine learning, computer vision, and synthetic data generation, the system ensures that each item in a customer's cart is accurately identified and matched against the originating TLOG. This reduces the likelihood of theft and fraud, enhances the customer experience by minimizing manual checks, and allows for real-time decision-making based on risk profiles.

An example of a procedure applied at an enhanced exit verification architecture (e.g., enhanced exit verification architecture 100) is illustrated in the flow diagram of FIG. 3. Specifically, FIG. 3 illustrates a data flow during a procedure 300 for a POS transaction at an enhanced exit verification architecture and/or enhanced exit verification system.

At operation 302, a member arrives at a POS system and begins a transaction (e.g., begins to “check out”). Details regarding the transaction are cached as data at the POS system (e.g., via a memory and one or more processors), then the data is processed and output as structured data. At operation 304, a transaction database receives the structured data associated with the transaction of operation 302 in the form of a TLOG. The TLOG is stored at the transaction database according to values stored therein, which may include but is not limited to: item identification information, quantity information, price information, checkout timestamp information, and the like. In some examples, information in the TLOG is compared to inventory information at the transaction database and is used to augment the inventory information. At operation 306, information in the TLOG is used update customer information stored at the transaction database. In one example, the information in the TLOG include member account information and/or loyalty information which may be used to update an associated customer profile at the transaction database. In one example, the information in the TLOG may be used to update taxation information at the transaction database. In one example, the information in the TLOG may be used to update itemization information at the transaction database (e.g., via a feedback loop present in the data flow path of the enhanced exit verification architecture). Procedure 300 may enhance operational efficiency by streamlining the capture, processing, and updating of transaction data, which improves inventory management, customer profiles, and financial and/or inventory records.

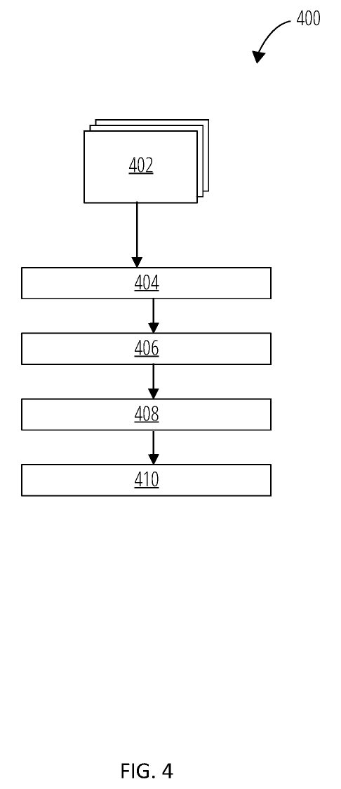

An example of a procedure applied at an enhanced exit verification architecture (e.g., enhanced exit verification architecture 100) is illustrated in the flow diagram of FIG. 4. Specifically, FIG. 4 illustrates a procedure 400 for data flow at an exit camera setup associated with an enhanced exit verification architecture and/or enhanced exit verification system.

At operation 402, which may be implemented via a distributed system component (e.g., array of sensing devices 110a-c of FIG. 1), one or more sensing devices coordinate to capture image information in real-time (e.g., monitor) regarding an exit of a facility (e.g., facility 124). In at least one aspect, the one or more sensing devices may be configured or otherwise arranged to capture multiple angles of a member's cart. In one example, the sensing devices may be arranged in a circular pattern around a cart exit location, with each camera positioned at equal intervals for comprehensive coverage. In another example, the sensing devices may be mounted at varying heights (e.g., on vertical poles) to capture high-speed frames from overhead and side perspectives. In another example, the sensing devices may be placed at the corners of a frame (e.g., a rectangular frame) around a cart exit location, providing diagonal and horizontal views of an exiting cart. In another example, the sensing devices may be mounted on adjustable arms extending from a central hub above the cart exit location for dynamic repositioning. In another example, the sensing devices may be mounted on rails parallel to the cart's path, allowing the sensing devices to move in sync with the cart. Additional examples may include overhead tracks for lateral movement, U-shaped frames for front, side, and rear coverage, telescoping mounts for varying distances, a combination of fixed and rotating mounts, and embedding sensing devices in the floor and ceiling for vertical perspectives. In at least one aspect, about five sensing devices or more to about 12 sensing devices or less, such as about 8 to 9 sensing devices may be used to capture high-speed images of the cart exit area.

In at least one aspect, the one or more sensing devices of procedure 400 may include closed-circuit television (CCTV) system cameras, internet protocol (IP) cameras, wireless cameras, pan-tilt-zoom (PTZ) cameras, charged-coupled device (CCD) cameras, thermal cameras, motion detection cameras, facial recognition cameras, bullet cameras, dome cameras, day/night cameras, infrared (IR) cameras, 360-degree cameras, hidden cameras, high-definition (HD) cameras, varifocal cameras, and network video recorders (NVRs).

At operation 404, the one or more sensing devices forward captured image information to a vision buffer, which feeds into a vision pipeline and ultimately delivers the image data to a computer vision component (e.g., computer vision engine 108 and/or computer vision unit 114). Upon delivery to the computer vision component at operation 406, the computer vision component applies bounding boxes and class labels to the image data via a classifier to construct item information. In at least one example, the computer vision component may utilize certain deterministic techniques (e.g., edge detection, histogram equalization, image filtering, morphological operations, Fourier transform, Gaussian blur, image resizing, thresholding, image rotation and translation, color space conversion, template matching, image segmentation, and convolution) to isolate items in the cart and eliminate noise.

At operation 408, the computer vision component delivers the constructed item information to a machine learning component (e.g., machine learning engine 106, machine learning unit 112). The machine learning component may refine the constructed item information based on one or more machine learning models to produce refined item information and may cross-reference the refined item information with additional information, such as historical shopping patterns, product co-occurrence likelihoods, and member profiles. At operation 410, the refined item information is delivered to a verification component (e.g., verification engine 126) where the itemization is verified against an associated TLOG to generate a confidence scored associated with the refined information.

Procedure 400 may improve the accuracy and efficiency of verifying items in a member's cart by utilizing multiple sensing devices to capture comprehensive, high-speed images from various angles, which are then processed through computer vision and machine learning components to ensure accurate itemization and verification against transaction logs.

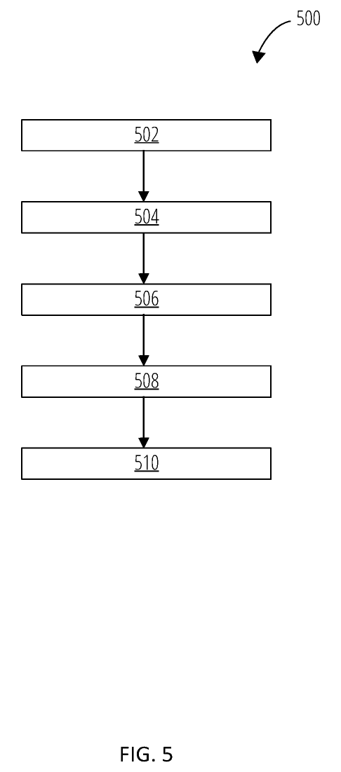

An example of a procedure applied at an enhanced exit verification architecture (e.g., enhanced exit verification architecture 100) is illustrated in the flow diagram of FIG. 5. Specifically, FIG. 5 illustrates a procedure 500 for continuous learning and improvement at a machine learning component (e.g., machine learning engine 106, machine learning unit 112) associated with an enhanced exit verification architecture and/or enhanced exit verification system. In some examples, procedure 500 may be facilitated via a feedback loop present in the data flow path of the enhanced exit verification architecture.

At operation 502, the machine learning component may monitor an exit area of a facility (e.g., facility 124) in a continuous or semi-continuous manner to perform refinement and verification consistent with description provided with respect to FIGS. 1-4. Based on the monitoring and subsequent performance, the machine learning component may proceed to operation 504. At operation 504, the machine learning component may train one or more machine learning models and may update associated data pipelines based on the training. Training the machine learning models may occur based on historical shopping patterns, product co-occurrence likelihoods, and member profiles, and may also occur based on performance during operation 502.

At operation 506, the machine learning component may construct (e.g., generate) synthetic data using the trained machine learning models. In at least one aspect, the synthetic data may be used to recursively train the one or more machine learning models. At operation 508, the synthetic data may be compared to a TLOG or other historical data to adjust weights of the one or more machine learning models. In at least one aspect, operation 508 is a recursive step performed in real-time based on the initial performance at operation 502. At operation 510, the machine learning component deploys the trained and refined machine learning models within the enhanced exit verification architecture. Once deployed, the procedure 500 will run in a continuous or semi-continuous manner, refining the machine learning models and improving their accuracy over time.

### Example Machine Learning Techniques

As used herein, the term “machine learning” can refer to an application of artificial intelligence technologies to automatically and/or autonomously learn and/or improve from an experience (e.g., training data) without explicit programming of the lesson learned and/or improved upon. Machine learning as used herein can include, but is not limited to, deep learning techniques. Various system components described herein can utilize machine learning (e.g., via supervised, unsupervised, and/or reinforcement learning techniques) to perform tasks such as classification, regression, and/or clustering. Execution of machine learning tasks can be facilitated by one or more machine learning models trained on one or more training datasets in accordance with one or more model configuration settings.

As used herein, the term “machine learning model” can refer to a computer model used to facilitate one or more machine learning tasks (e.g., regression and/or classification tasks). For example, a machine learning model can represent relationships (e.g., causal or correlation relationships) between parameters and/or outcomes within the context of a specified domain. For instance, machine learning models can represent the relationships via probabilistic determinations that can be adjusted, updated, and/or redefined based on historic data and/or previous executions of a machine learning task. In various embodiments described herein, machine learning models can simulate a number of interconnected processing units that can resemble abstract versions of neurons. For example, the processing units can be arranged in a plurality of layers (e.g., one or more input layers, hidden layers, and/or output layers) connected by varying connection strengths (e.g., which can be commonly referred to within the art as “weights”).

Machine learning models can learn through training with one or more training datasets; where data with known outcomes in inputted into the machine learning model, outputs regarding the data are compared to the known outcomes, and/or the weights of the machine learning model are autonomously adjusted based on the comparison to replicate the known outcomes. As the one or more machine learning models train (e.g., utilize more training data), the machine learning models can become increasingly accurate; thus, trained machine learning models can accurately analyze data with unknown outcomes, based on lessons learned from training data and/or previous executions, to facilitate one or more machine learning tasks.

Example types of machine learning models can include, but are not limited to: artificial neural network (“ANN”) models, perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, generative artificial intelligence (“GenAI”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, large language learning (“LLM”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

Moreover, as used herein, the term “GenAI” can refer to a type of machine learning model designed to generate new content based on patterns learned from training data. GenAI models are capable of creating text, images, music, and other forms of data via replication of underlying structures and relationships within the training data. For example, an exemplary GenAI model can produce realistic images by learning the statistical properties of a dataset of photographs or generate coherent text by understanding the syntax and semantics of a large corpus of written language (e.g., an LLM). These models can represent relationships (e.g., causal or correlation relationships) between parameters and/or outcomes within the context of a specified domain, and they can adjust, update, and/or redefine these relationships based on historic data and/or previous executions of a generative task.

GenAI models can learn through training with one or more training datasets; where data with known outcomes is input into the GenAI model, and the model generates outputs that are compared to the known outcomes. The weights of the GenAI model are adjusted based on the comparison to replicate the known outcomes. As the GenAI models trains (e.g., utilize more training data), it becomes increasingly accurate and capable of producing high-quality, realistic outputs. Thus, trained GenAI models can generate new content to a certain degree of accuracy based on lessons learned from training data and/or previous executions.

Examples of GenAI models include, but are not limited to: Generative Pre-trained Transformer (“GPT”) models, such as GPT-3, GPT-4, GPT-Neo and GPT-J, DALL-E models, GAN models, such as BigGAN and StyleGAN, bidirectional encoder representations from transformers (“BERT”) models, text-to-text transfer transformer (“T5”) models, conditional transformer language (“CTRL”) models, codex models, vector quantized variational autoencoders (“VQ-VAE”) models, reformer models, and contrastive language-image pre-training (“CLIP”) models.

Moreover, various aspects described herein can constitute one or more technical improvements over conventional exit verification architectures by continuously capturing and processing real-time data from multiple angles to enhance item verification accuracy. This is achieved through the use of an array of sensing devices strategically positioned to provide comprehensive coverage of the cart exit area. Additionally, one or more aspects described herein can have a practical application by training machine learning models to perform continuous learning and improvement operations in accordance with defined retail security objectives.

For example, one or more aspects described herein can improve the accuracy and efficiency of verifying items in a member's cart by utilizing advanced computer vision techniques, such as determinative techniques escribed herein, to isolate items and eliminate noise. The machine learning engine can be executed to detect anomalies and new items in the cart, retraining the computer vision model based on this new data. This approach leverages GenAI to create synthetic data for recursive training, ensuring the models remain up-to-date and accurate.

The GenAI functionality may include the use of convolutional neural networks (CNNs) for image recognition and classification, which apply multiple layers of filters to detect and learn features from the captured images. The system may additionally employ recurrent neural networks (RNNs) to analyze sequences of images over time, enhancing the detection of patterns and anomalies. Additionally, the machine learning models may be continuously updated using reinforcement learning, where the system learns optimal actions through trial and error, guided by a reward mechanism based on the accuracy of item verification.

In at least one additional embodiment, the GenAI component may utilize techniques such as Generative Adversarial Networks (GANs) to produce synthetic data that mimics real-world scenarios, providing diverse training examples to improve model robustness. This synthetic data may be used to augment the training dataset, allowing the machine learning models to generalize better to new and unseen data.

Thereby, the enhanced exit verification engine can strengthen the system over time with minimal human intervention, continuously refining the machine learning models and improving their accuracy through real-time data capture and processing. This iterative learning process ensures that the system adapts to changing conditions and maintains high verification accuracy.

### Example Use-Cases for an Enhanced Exit Verification System

The following are non-limiting examples of transactions that utilize the systems and methods provided herein.

Example 1: A customer enters a member's exclusive store and selects a robust spread of breakfast items, placing the items into their shopping cart. As the customer approaches the checkout area, they proceed to a POS system to purchase the breakfast items. The POS system generates a TLOG based on the selected breakfast items. As the customer moves towards the exit, they push their cart through an array of cameras positioned to capture multiple angles of the cart's contents. The computer vision system takes several high-speed images of the breakfast items and sends the images to an inferencing engine. The inferencing engine analyzes the images and matches the detected items breakfast items to the corresponding TLOG. In this instance, there are no discrepancies between the breakfast items detected by the computer vision system and the breakfast items listed in the TLOG. The enhance exit verification system confirms that all items in the cart match the TLOG accurately. As a result, the customer is allowed to exit the store without any further inspection.

Example 2: A store operator manages the checkout area, relying on the enhanced exit verification system described herein to ensure a smooth and efficient process. A customer completes their transaction and a TLOG is produced detailing all purchased items. As the customer approaches the exit, the store operator monitors a user interface of the enhanced exit system as the customer pushes their cart through an array of cameras capturing multiple angles of the cart's contents. In this case, the enhanced exit verification system identifies discrepancies between the items in the cart and the TLOG. The system alerts the store operator to the variance, prompting a manual inspection. The store operator approaches the customer and reviews TLOG and the items detected by the enhanced exit verification system. The store operator compares the items in the cart with the transaction log to identify the source of the discrepancy. By promptly addressing the issue, the store operator ensures that all items are accounted for and resolves any potential errors. The feedback from the manual inspection is used to enhance the accuracy of the enhanced exit verification system, continuously refining the system for future transactions.

Example 3: A member identified by their unique customer ID has a risk profile that indicates a “high risk” for theft. The member completes their purchase at POS system. A TLOG is generated, detailing all items bought, including applied discounts and quantities. As the member approaches the exit, the verification engine identifies a discrepancy between the items in the member's cart and the TLOG. The system alerts a store operator, who performs a manual check and resolves the issue. Because the member has a “high risk” profile, the store operator performs a more thorough inspection of the member's cart. The member's risk profile, based on the outcome me of the inspection, is refined by the enhanced exit verification system to ensure greater prediction accuracy for future transactions associated with the member.

The implementation of systems and methods described herein may significantly enhance the accuracy of product identification, effectively addressing challenges such as packaging variations, seasonality, and lighting conditions. For example, the enhanced exit verification architecture leverages GenAI techniques to refine computer vision outputs, creating synthetic training data and simulating new product packaging or conditions, thereby ensuring ongoing accuracy without extensive manual retraining. The generative AI model can incorporate contextual and historical shopping patterns, product co-occurrence likelihoods, and member purchase histories and risk profiles to resolve ambiguities and suggest probable item matches.

Systems and methods provided herein also confer immediate benefits via real-time synergy with POS TLOGs, ensuring that data collected at the point of sale is immediately available for cross-referencing and validation. This real-time data integration helps to quickly identify discrepancies and streamline the verification process, ensuring rapid throughput and reduced wait times at the exit.

Furthermore, the system provided herein continually improves, leveraging feedback from successful verifications, anomalies, and seasonal changes, thus remaining agile in the face of evolving inventory and store conditions. Additionally, systems and methods provided herein are configured to facilitate continuous scalability improvements, allowing the enhanced exit verification architecture to evolve and adapt as new data is captured. This ensures that the system remains effective and efficient over time, providing a robust solution for product identification and verification in retail and wholesale settings.

### Example Method

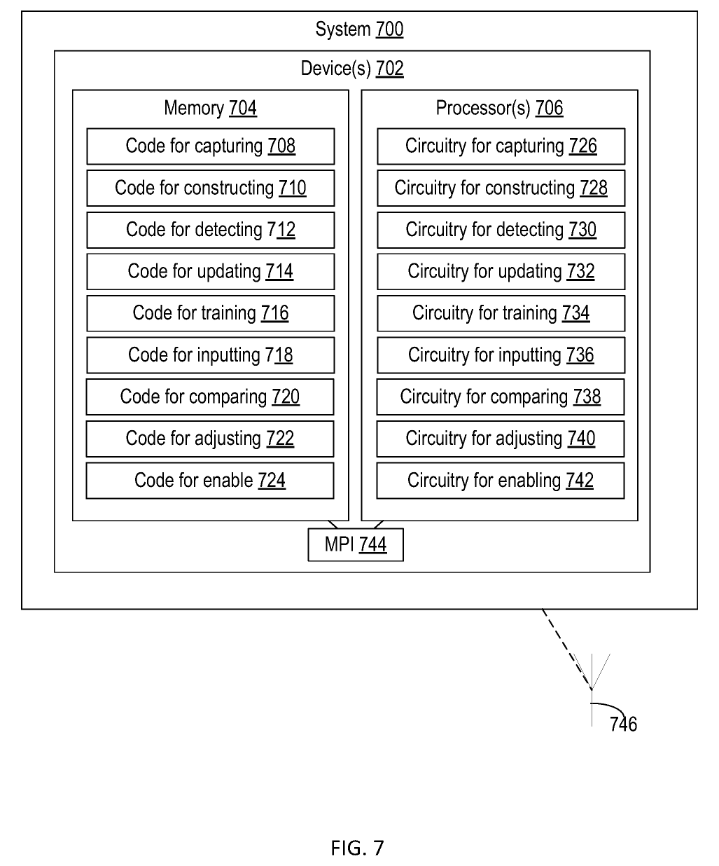

FIG. 6 is a schematic flowchart of an example method 600 for enhanced exit verification by one or more processors, such as processors of enhanced exit verification architecture 100 of FIG. 1 and/or the processors of the system 700 of FIG. 7.

Method 600 begins at operation 602 with one or more processors capturing, in real-time and as a customer approaches an exit, a set of images of one or more items.

Method 600 continues to operation 604 with one or more processors constructing, via a computer vision engine, a preliminary item catalog based on the one or more items detected near the exit.

Method 600 continues to operation 606 with one or more processors constructing, via a machine learning engine and based on the preliminary item catalog, a refined item catalog by cross-referencing attributes of the one or more items against at least one of synthetic data, historical purchase patterns, contextual product groupings, and known inventory information.

Method 600 continues to operation 608 with one or more processors detecting, via a verification engine and in real-time, discrepancies between the refined item catalog and a corresponding transaction log obtained from a transaction database, wherein the customer is allowed to pass through the exit based on the discrepancies.

In at least one aspect, method 600 may include an operation by one or more processors to update at least one of the computer vision engine and the machine learning engine based on aggregate verification outcomes, the aggregate verification outcomes based on the discrepancies.

In at least one aspect, method 600 may include an operation by one or more processors to train the one or more machine learning models and an inference engine configured to apply the one or more machine learning models to at least the preliminary item catalog. In at least one example, wherein the training engine is configured to train the one or more machine learning models by: inputting at least one training dataset, the training dataset based on at least one of real-time customer information and real-time inventory information; comparing, to the at least one training dataset, at least one outputs of the training engine; and based on the comparing, adjusting one or more weights of the one or more machine learning models. In at least one example, adjusting one or more weights includes adjusting item confidence levels based on past member transactions. In at least one example, the training engine is configured to train the machine learning based on at least one of common product co-occurrences, promotional items, and member-specific purchase histories. In at least one example, the inference engine is configured to apply the one or more machine learning models to a set of synthetic input data to generate a set of synthetic training images. In at least one example, the set of synthetic training images includes synthetic images of products, wherein the synthetic images of products represent at least one of: the products exposed to a plurality of lighting configurations; the products having varied packaging; and the products appearing in a plurality of spatial conditions. In at least one example, the machine learning engine uses generative artificial intelligence.

In at least one aspect, method 600 may include an operation by one or more processors to update the computer vision engine, the machine learning engine, or both the computer vision engine and the machine learning engine based on the discrepancies.

In at least one aspect, method 600 may include an operation by one or more processors to enable a user to view informatics based on the discrepancies.

In at least one aspect, method 600 may include an operation by one or more processors to capture images of the one or more items near the exit. In at least one example, the one or more items include items collected by the customer and brought to the exit. construct the corresponding transaction log based on a transaction by the customer; and output the corresponding transaction log to the transaction database.

In one aspect, method 600, or any aspect related to it, may be performed by a system, device, apparatus, or architecture, such as the enhanced data processing architecture of FIG. 1 or system 700 of FIG. 7, which includes various components operable, configured to, or adapted to perform the method 600. System 700 is described below in further detail.

FIG. 6 is just one example of a method, and other methods including fewer, additional, or alternative operations are contemplated consistent with the disclosure.

### Example Systems and Devices

FIG. 7 illustrates a schematic diagram of an example system 700, which includes a device(s) 702. The system 700 may be implemented as part of the enhanced exit verification procedures described with respect to FIGS. 1-6. The device(s) 702 may be implemented at a single location or at multiple locations and may be a supervisory system component or may be in communication with a supervisory system component by way of a communication line and/or communication connection. In at least one aspect, the communication line and/or communication connection may be a wireless communication line, a wired communication line, or both, though other types of communication line or connection are contemplated.

The device(s) 702 may include a CPU processing system, which may be configured to implement enhanced exit verification, as performed by the system 700. The CPU processing system of the device(s) 702 may include one or more processors 706 coupled to a computer readable medium/memory 704 (e.g., via a bus (not shown)). The one or more processors 706 and the computer readable medium/memory 704 may communicate via a message passing interface (MPI) 744 (or some other suitable communication interface). In certain aspects the computer readable medium/ memory 704 is configured to store instructions (e.g., computer executable code) that when executed by the one or more processors 706, cause the one or more processors to perform the method 600 described with respect to FIG. 6, or any aspect related to it. Reference to a processor performing a function of system 700 may include one or more processors performing that function of system 700.

In the depicted example, computer-readable medium/memory 704 stores code 708 (e.g., executable instructions) for capturing, code 710 for constructing, code 712 for detecting, code 714 for updating, code 716 for training, code 718 for inputting, code 720 for comparing, code 722 for adjusting, and code 724 for enabling. Processing of code 708-724 may cause the system 700 to perform the method 600 described with respect to FIG. 6, or any aspect related to it.

The one or more processors 706 include circuitry configured to implement (e.g., execute) the code stored in the computer-readable medium / memory 704, including circuitry 726 capturing, circuitry 728 for constructing, circuitry 730 for detecting, circuitry 732 for updating, circuitry 734 for training, circuitry 736 for inputting, circuitry 738 for comparing, circuitry 740 for adjusting, and circuitry 742 for enabling. Processing with circuitry 726-742 may cause the system 700 to perform the method 600 described with respect to FIG. 6, or any aspect related to it.

Various components of the system 700 may provide means for performing the method 600 described with respect to FIG. 7, or any aspect related to it.

The system 700 may include or be substantially coupled to a communication component 746. In the depicted example, the communication component 746 is an antenna capable of communicating with systems or system components similar to system 700 to perform the method 600 described with respect to FIG. 6, or any aspect related to it. In additional examples, the communication component 746 may be a bus or a wired connection.

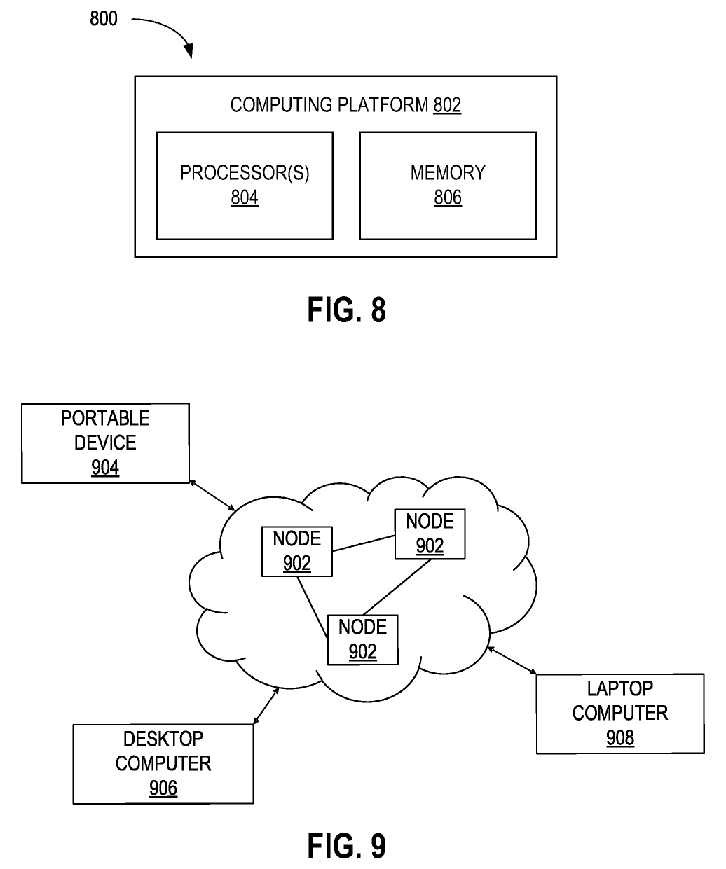

FIG. 8 is an example of a block diagram of a system 800. The system 800 can be implemented using one or more modules, shown in block form in the drawings. The one or more modules can be in software or hardware form, or a combination thereof. In some examples, the system 800 can be implemented as machine readable instructions for execution on one or more computing platforms 802 (referred to as a computing platform herein), as shown in FIG. 8. The computing platform 802 can include one or more computing devices selected from, for example, a desktop computer, a server, a controller, a blade, a mobile phone, a tablet, a laptop, a personal digital assistant (PDA), and the like.

The computing platform 804 can include a processor 804 and a memory 806. By way of example, the memory 806 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 804 can be implemented, for example, as one or more processor cores. The memory 806 can store machine-readable instructions that can be retrieved and executed by the processor 804 to implement the system 800. Each of the processor 804 and the memory 806 can be implemented on a similar or a different computing platform. The computing platform 802 can be implemented in a cloud computing environment (for example, as disclosed herein) and thus on a cloud infrastructure. In such a situation, features of the computing platform 802 can be representative of a single instance of hardware or multiple instances of hardware executing across the multiple of instances (e.g., distributed) of hardware (e.g., computers, routers, memory, processors, or a combination thereof). Alternatively, the computing platform 802 can be implemented on a single dedicated server or workstation. In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 8. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (SaaS, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

FIG. 9 is an example of a cloud computing environment 900 that can be used for implementing one or more modules and/or systems in accordance with one or more examples, as disclosed herein. Thus, reference can be made to one or more examples of FIGS. 1-8 in the example of FIG. 9. As shown, cloud computing environment 900 can include one or more cloud computing nodes 902 with which local computing devices used by cloud consumers (or users), such as, for example, personal digital assistant (PDA), cellular, or portable device 904, a desktop computer 906, and/or a laptop computer 908, may communicate. The computing nodes 902 can communicate with one another. In some examples, the computing nodes 902 can be grouped (not shown) physically or virtually, in one or more networks, such as Private, Community, Public, or Hybrid clouds, or a combination thereof. This allows the cloud computing environment 900 to offer infrastructure, platforms and/or software as services for which a cloud consumer does not need to maintain resources on a local computing device. The devices 904-908, as shown in FIG. 9, are intended to be illustrative and that computing nodes 902 and cloud computing environment 900 can communicate with any type of computerized device over any type of network and/or network addressable connection (e.g., using a web browser). In some examples, the one or more computing nodes 902 are used for implementing one or more examples disclosed herein relating to root-source identification. Thus, in some examples, the one or more computing nodes can be used to implement modules, platforms, and/or systems, as disclosed herein.

In some examples, the cloud computing environment 900 can provide one or more functional abstraction layers. It is to be understood that the cloud computing environment 900 need not provide all of the one or more functional abstraction layers (and corresponding functions and/or components), as disclosed herein. For example, the cloud computing environment 900 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 900 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 900 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 900, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 900 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 900 can provide a workloads layer that provides examples of functionality for which the cloud computing environment 900 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 900.

Systems and methods provided herein may be implemented using serverless architecture, such as a “Kubernetes” architecture. Kubernetes is an open-source container orchestration platform that may manage containerized applications across a cluster of nodes. Within its architecture, several data types are integral to its operation and management. These data types include “Pods,” which are the smallest and simplest Kubernetes objects that represent a single instance of a running process in a cluster. “Nodes,” another critical data type, are the worker machines in Kubernetes, which can be either virtual or physical. Deployments are used to manage a set of identical Pods, ensuring that the desired number of Pods are running at any given time. Services, which define a logical set of Pods and a policy by which to access them, are useful for facilitating network access to the Pods. “ConfigMaps” and “Secrets” are used to manage configuration data and sensitive information, respectively. “PersistentVolumes” and “PersistentVolumeClaims” handle storage resources, allowing Pods to request and use storage dynamically. - Namespaces provide a mechanism to partition resources within a single Kubernetes cluster, facilitating multi-tenancy and resource management.

In Kubernetes architectures, various types of databases can be deployed to manage and store data efficiently. Relational databases, such as “MySQL” and “PostgreSQL,” are commonly used for structured data and support atomicity, consistency, isolation, and durability (ACID) transactions, making them suitable for applications requiring complex queries and data integrity. “NoSQL” databases, including “MongoDB” and “Cassandra,” are designed for unstructured data and offer high scalability and flexibility, which may be useful for applications with large volumes of data and varying data models. Key-Value stores like “Redis” and “etcd” are optimized for fast read and write operations, often used for caching and configuration management. Time-series databases, such as “InfluxDB” and “Prometheus,” are specialized for handling time-stamped data, making them perfect for monitoring and analytics applications. Additionally, “NewSQL” databases, like “CockroachDB,” combine the scalability of NoSQL systems with the ACID guarantees of traditional relational databases, providing a balanced solution for modern applications. These diverse database types enable Kubernetes to support a wide range of application requirements, from transactional systems to real-time analytics and beyond.

### Example Aspects

Implementation examples are described in the following numbered clauses:

Aspect 1: A system for store exit verification, including a computer vision engine, the computer vision unit configured to, in real-time and as a customer approaches an exit, construct a preliminary item catalog based on one or more items detected near the exit; a machine learning engine communicatively coupled to the computer vision unit and having one or more machine learning models, the one or more machine learning models trained to construct, based on the preliminary item catalog, a refined item catalog by cross-referencing attributes of the one or more items against at least one of synthetic data, historical purchase patterns, contextual product groupings, and known inventory information; and a verification engine communicatively coupled to the machine learning unit and a transaction database, the verification engine configured to detect, in real-time, discrepancies between the refined item catalog and a corresponding transaction log obtained from the transaction database, wherein the customer is allowed to pass through the exit based on the discrepancies.

Aspect 2: The system of aspect 1, wherein the machine learning engine includes a training engine configured to train the one or more machine learning models and an inference engine configured to apply the one or more machine learning models to at least the preliminary item catalog.

Aspect 3: The system of aspect 2, wherein the training engine is configured to train the one or more machine learning models by: inputting at least one training dataset, the training dataset based on at least one of real-time customer information and real-time inventory information; comparing, to the at least one training dataset, at least one outputs of the training engine; and based on the comparing, adjusting one or more weights of the one or more machine learning models.

Aspect 4: The system of aspect 3, wherein adjusting one or more weights includes adjusting item confidence levels based on past member transactions.

Aspect 5: The system of any one of aspects 2 through 4, wherein the training engine is configured to train the machine learning based on at least one of common product co-occurrences, promotional items, and member-specific purchase histories.

Aspect 6: The system of any one of aspects 2 through 5, wherein the inference engine is configured to apply the one or more machine learning models to a set of synthetic input data to generate a set of synthetic training images.

Aspect 7: The system of aspect 6, wherein the set of synthetic training images includes synthetic images of products, wherein the synthetic images of products represent at least one of: the products exposed to a plurality of lighting configurations; the products having varied packaging; and the products appearing in a plurality of spatial conditions.

Aspect 8: The system of any one of aspects 1 through 7, further including a feedback loop that updates the computer vision engine, the machine learning engine, or both the computer vision engine and the machine learning engine based on the discrepancies.

Aspect 9: The system of any one of aspects 1 through 8, further including a device communicatively coupled to the verification engine and having a user-interface configured to enable a user to view informatics based on the discrepancies.

Aspect 10: The system of any one of aspects 1 through 9, wherein the machine learning engine uses generative artificial intelligence.

Aspect 11: The system of any one of aspects 1 through 10, further including one or more sensing devices communicatively coupled to the computer vision engine and configured to capture images of the one or more items near the exit.

Aspect 12: The system of any one of aspects 1 through 11, wherein the one or more items include items collected by the customer and brought to the exit.

Aspect 13: The system of any one of aspects 1 through 12, further including a primary unit having one or more processors coupled to a memory having computer-readable instructions stored thereon.

Aspect 14: The system of any one of aspects 1 through 13, further including a primary unit having one or more processors coupled to a memory having computer-readable instructions stored thereon; and a computer vision unit housed at the primary unit and configured to implement the computer vision engine.

Aspect 15: The system of any one of aspects 1 through 14, further including a primary unit having one or more processors coupled to a memory having computer-readable instructions stored thereon; and a machine learning unit housed at the primary unit and configured to implement the machine learning engine.

Aspect 16: The system of any one of aspects 1 through 15, further including a primary unit having one or more processors coupled to a memory having computer-readable instructions stored thereon; and wherein the transaction database is housed at the primary unit.

Aspect 17: The system of any one of aspects 1 through 16, further including a primary unit having one or more processors coupled to a memory having computer-readable instructions stored thereon, the primary unit configured to implement the verification engine.

Aspect 18: The system of any one of aspects 1 through 17, further including one or more point of sale units configured to: construct the corresponding transaction log based on a transaction by the customer; and output the corresponding transaction log to the transaction database.

Aspect 19: A method for store exit verification, including capturing, in real-time and as a customer approaches an exit, a set of images of one or more items; constructing, via a computer vision engine, a preliminary item catalog based on the one or more items detected near the exit; constructing, via a machine learning engine and based on the preliminary item catalog, a refined item catalog by cross-referencing attributes of the one or more items against at least one of synthetic data, historical purchase patterns, contextual product groupings, and known inventory information; and detecting, via a verification engine and in real-time, discrepancies between the refined item catalog and a corresponding transaction log obtained from a transaction database, wherein the customer is allowed to pass through the exit based on the discrepancies.

Aspect 20: The method of aspect 19, further including updating at least one of the computer vision engine and the machine learning engine based on aggregate verification outcomes, the aggregate verification outcomes based on the discrepancies.

Aspect 21: The method of any one of aspects 19 through 20, wherein the machine learning engine includes a training engine configured to train the one or more machine learning models and an inference engine configured to apply the one or more machine learning models to at least the preliminary item catalog.

Aspect 22: The method of aspect 21, wherein the training engine is configured to train one or more machine learning models by: inputting at least one training dataset, the training dataset based on at least one of real-time customer information and real-time inventory information; comparing, to the at least one training dataset, at least one outputs of the training engine; and based on the comparing, adjusting one or more weights of the one or more machine learning models.

Aspect 23: The method of aspect 22, wherein adjusting one or more weights includes adjusting item confidence levels based on past member transactions.

Aspect 24: The method of any one of aspects 21 through 23, wherein the training engine is configured to train the machine learning based on at least one of common product co-occurrences, promotional items, and member-specific purchase histories.

Aspect 25: The method of any one of aspects 21 through 24, wherein the inference engine is configured to apply the one or more machine learning models to a set of synthetic input data to generate a set of synthetic training images.

Aspect 26: The method of aspect 25, wherein the set of synthetic training images includes synthetic images of products, wherein the synthetic images of products represent: the products exposed to a plurality of lighting configurations; the products having varied packaging; and the products appearing in a plurality of spatial conditions.

Aspect 27: The method of any one of aspects 19 through 26, wherein the machine learning engine uses generative artificial intelligence.

Aspect 28: The method of any one of aspects 19 through 22, further including: constructing, at one or more point of sale units, the corresponding transaction log based on a transaction by the customer; and outputting the corresponding transaction log to the transaction database.

Aspect 29: A system for store exit verification, including: one or more point of sale units configured to construct a transaction log based on a transaction by a customer and output the transaction log to a transaction database; one or more sensing devices configured to, in real-time and as a customer approaches an exit, capture images of one or more items near the exit; a primary unit having one or more processors coupled to a memory having computer-readable instructions stored thereon, the primary unit including: a computer vision engine communicatively coupled to the one or more sensing devices, the computer vision unit configured to construct a preliminary item catalog based the on one or more items; a machine learning engine communicatively coupled to the computer vision unit and having one or more machine learning models, the one or more machine learning models trained to construct, based on the preliminary item catalog, a refined item catalog by cross-referencing attributes of the one or more items against at least one of synthetic data, historical purchase patterns, contextual product groupings, and known inventory information; and a verification engine communicatively coupled to the machine learning unit and a transaction database, the verification engine configured to detect, in real-time, discrepancies between the refined item catalog and the transaction log obtained from the transaction database, wherein the customer is allowed to pass through the exit based on the discrepancies; and a device communicatively coupled to the verification engine and having a user-interface configured to enable a user to view informatics based on the discrepancies.

Aspect 30: The system of aspect 29, wherein the computer vision engine is housed at a computer vision unit; and the machine learning engine is housed at a machine learning unit.

Aspect 31: An apparatus or device including a memory comprising executable instructions, and a processor configured to execute the executable instructions and cause the apparatus to perform a method in accordance with any one of aspects 1-30.

Aspect 32: An apparatus or device, including means for performing a method in accordance with any one of aspects 1-30.

Aspect 33: A non-transitory computer-readable medium including executable instructions that, when executed by a processor of an apparatus, cause the apparatus to perform a method in accordance with any one of aspects 1-30.

Aspect 34: A computer program product embodied on a computer-readable storage medium comprising code for performing a method in accordance with any one of aspects 1-30.

### Additional Considerations

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

The present disclosure may be a system, a method, and/or a computer program product at any possible technical detail level of integration. The computer program product may include a computer readable storage medium (or media) having computer readable program instructions thereon for causing a processor to conduct aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or conduct combinations of special purpose hardware and computer instructions.

“Real-time” may refer to the capability of a system or process to respond to inputs or events within a strict period of time, such as immediately or within seconds or milliseconds. In computing and information technology, real-time systems may be designed to process data and provide outputs instantaneously or almost instantaneously, ensuring minimal latency.

“Continuous” may refer to operating without interruption, constantly monitoring and responding in real-time to changes, ensuring a seamless flow of operations. Examples include real-time video surveillance and live data streaming.

“Semi-continuous”, also known as quasi-continuous or intermittent, may refer to activity occurring in regular intervals or cycles, pausing briefly between periods of activity. This allows for periodic updates while maintaining consistent performance. Examples include batch processing and scheduled data synchronization.

“Event-based”, or event-driven, may refer to activity occurring in response to specific occurrences or triggers (e.g., rather than functioning continuously). An event-based system remains idle until an event of interest occurs, then processes the event and performs necessary tasks. Examples include security alarms and user interface interactions.

The terminology used herein is for the purpose of describing particular embodiments only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for conducting this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system for store exit verification, comprising
a computer vision engine, the computer vision engine configured to, in real-time and as a customer approaches an exit, construct a preliminary item catalog based on one or more items detected near the exit;
a machine learning engine communicatively coupled to the computer vision engine and having one or more machine learning models, the one or more machine learning models trained to construct, based on the preliminary item catalog, a refined item catalog by cross-referencing attributes of the one or more items against at least one of synthetic data, historical purchase patterns, contextual product groupings, and known inventory information; and
a verification engine communicatively coupled to the machine learning engine and a transaction database, the verification engine configured to detect, in real-time, discrepancies between the refined item catalog and a corresponding transaction log obtained from the transaction database, wherein the customer is allowed to pass through the exit based on the discrepancies.

2. The system of claim 1, wherein the machine learning engine comprises a training engine configured to train the one or more machine learning models and an inference engine configured to apply the one or more machine learning models to at least the preliminary item catalog.

3. The system of claim 2, wherein the training engine is configured to train the one or more machine learning models by:
inputting at least one training dataset, the training dataset based on at least one of real-time customer information and real-time inventory information;
comparing, to the at least one training dataset, at least one outputs of the training engine; and
based on the comparing, adjusting one or more weights of the one or more machine learning models.

4. The system of claim 3, wherein adjusting one or more weights comprises adjusting item confidence levels based on past member transactions.

5. The system of claim 2, wherein the training engine is configured to train the machine learning based on at least one of common product co-occurrences, promotional items, and member-specific purchase histories.

6. The system of claim 2, wherein the inference engine is configured to apply the one or more machine learning models to a set of synthetic input data to generate a set of synthetic training images.

7. The system of claim 6, wherein the set of synthetic training images comprises synthetic images of products, wherein the synthetic images of products represent at least one of:
the products exposed to a plurality of lighting configurations;
the products having varied packaging; and
the products appearing in a plurality of spatial conditions.

8. The system of claim 1, further comprising a feedback loop that updates the computer vision engine, the machine learning engine, or both the computer vision engine and the machine learning engine based on the discrepancies.

9. The system of claim 1, further including a device communicatively coupled to the verification engine and having a user-interface configured to enable a user to view informatics based on the discrepancies.

10. The system of claim 1, wherein the machine learning engine uses generative artificial intelligence.

11. The system of claim 1, further comprising one or more sensing devices communicatively coupled to the computer vision engine and configured to capture images of the one or more items near the exit.

12. The system of claim 11, wherein the one or more items comprise items collected by the customer and brought to the exit.

13. The system of claim 1, further comprising one or more point of sale units configured to:
construct the corresponding transaction log based on a transaction by the customer; and
output the corresponding transaction log to the transaction database.

14. A method for store exit verification, comprising:
capturing, in real-time and as a customer approaches an exit, a set of images of one or more items;
constructing, via a computer vision engine, a preliminary item catalog based on the one or more items detected near the exit;
constructing, via a machine learning engine and based on the preliminary item catalog, a refined item catalog by cross-referencing attributes of the one or more items against at least one of synthetic data, historical purchase patterns, contextual product groupings, and known inventory information; and
detecting, via a verification engine and in real-time, discrepancies between the refined item catalog and a corresponding transaction log obtained from a transaction database, wherein the customer is allowed to pass through the exit based on the discrepancies.

15. The method of claim 14, further comprising updating at least one of the computer vision engine and the machine learning engine based on aggregate verification outcomes, the aggregate verification outcomes based on the discrepancies.

16. The method of claim 14, wherein the machine learning engine comprises a training engine configured to train the one or more machine learning models and an inference engine configured to apply the one or more machine learning models to at least the preliminary item catalog.

17. The method of claim 16, wherein the training engine is configured to train one or more machine learning models by:
inputting at least one training dataset, the training dataset based on at least one of real-time customer information and real-time inventory information;
comparing, to the at least one training dataset, at least one outputs of the training engine; and
based on the comparing, adjusting one or more weights of the one or more machine learning models.

18. The method of claim 16, wherein the training engine is configured to train the machine learning based on at least one of common product co-occurrences, promotional items, and member-specific purchase histories.

19. The method of claim 16, wherein the inference engine is configured to apply the one or more machine learning models to a set of synthetic input data to generate a set of synthetic training images.

20. A system for store exit verification, comprising:
one or more point of sale units configured to construct a transaction log based on a transaction by a customer and output the transaction log to a transaction database;
one or more sensing devices configured to, in real-time and as a customer approaches an exit, capture images of one or more items near the exit;
a primary unit having one or more processors coupled to a memory having computer-readable instructions stored thereon, the primary unit comprising:
a computer vision engine communicatively coupled to the one or more sensing devices, the computer vision engine configured to construct a preliminary item catalog based the on one or more items;
a machine learning engine communicatively coupled to the computer vision engine and having one or more machine learning models, the one or more machine learning models trained to construct, based on the preliminary item catalog, a refined item catalog by cross-referencing attributes of the one or more items against at least one of synthetic data, historical purchase patterns, contextual product groupings, and known inventory information; and
a verification engine communicatively coupled to the machine learning engine and a transaction database, the verification engine configured to detect, in real-time, discrepancies between the refined item catalog and the transaction log obtained from the transaction database, wherein the customer is allowed to pass through the exit based on the discrepancies; and
a device communicatively coupled to the verification engine and having a user-interface configured to enable a user to view informatics based on the discrepancies.
